(19) United States
(12) Patent Application Publication
(10) Pub. No.: US 2014/0190803 A1
(43) Pub. Date: Jul. 10, 2014

(54) LOAD TRANSFER SWITCH FOR A TAP CHANGER

(71) Applicants: Martin Jatta, Barbing (DE); Christian Kotz, Schorndorf (DE); Elke Wuersching nee Trué, Regenstauf (DE); Hubert Zwirgimaier, Regensburg (DE)

(72) Inventors: Martin Jatta, Barbing (DE); Christian Kotz, Schorndorf (DE); Elke Wuersching nee Trué, Regenstauf (DE); Hubert Zwirgimaier, Regensburg (DE)

(73) Assignee: UCL BUSINESSW PLC, London (GB)

(21) Appl. No.: 13/642,134

(22) PCT Filed: Feb. 23, 2011
(86) PCT No.: PCT/EP2011/000851

§ 371 Date: Jan. 28, 2013

(30) Foreign Application Priority Data
May 11, 2010 (DE) 10 2010 020 130.8

(51) Int. Cl. H01H 9/00

(52) U.S. Cl. CPC H01H 9/0027
USPC 200/11 TC

(57) ABSTRACT

The invention relates to a load transfer switch for a tap changer for switching among various winding taps of a step transformer without interruption. The general inventive concept lies in fastening both the force accumulator and the load transfer switch not on the bearing plate but rather on the force accumulator support by providing additional receptacles on the force accumulator support, which receptacles are supported over a large area on the oil tank, in particular on the upper permanent main contact supports fastened to the oil tank, of each phase of the load transfer switch in such a way that the force accumulator support is fixed both in the horizontal direction and the vertical direction and thus mechanically unburdens the bearing plate.

The invention relates to a load changeover switch for a tap changer for uninterrupted switching over between different winding taps of a tapped transformer, according to the preamble of the first patent claim.

Tap changers serve, as is known, for uninterrupted switching over between different winding taps of a tapped transformer and thus for voltage regulation. They usually consist of a selector for power-free preselection of that winding tap of the tapped transformer which is to be switched over to, as well as a load changeover switch for the actual uninterrupted switching over from the previously connected winding tap to the new, preselected winding tap. The load changeover switch has for that purpose the components required for such an uninterrupted, rapid switching over, particularly a force store, switch contacts—these can be mechanical switch contacts, vacuum switching cells or also thyristors—as well as means for actuation of the switch contacts in a predetermined switching sequence in each switching-over process.

Known load changeover switches usually additionally comprise an individual oil vessel, usually in the form of a closed insulating material cylinder, in which all mentioned components, separated from the surrounding oil of the transformer, are located. Arranged below the load changeover switch is the selector, which is located in the transformer oil. All components or elements of the load changeover switch are conceived within the separate oil vessel as a complete load changeover switch insert, which can be withdrawn in its entirety upwardly out of the oil vessel for, for example, inspections or maintenance without the entire tap changer having to be removed from the transformer vessel in which it is mounted. For that purpose, it is known from, for example, the company publications ‘Stufenschalter Typ R und RM-Inspektionsanleitung’ and ‘Stufenschalter Typ R und RM-Technische Daten’ of the applicant to provide at the load changeover switch insert a supporting cylinder of insulating material which in the installed state extends concentrically within the individual oil vessel. The upper closure of the support cylinder forms a support plate. The subassemblies, which are described further above, of the load changeover switch are suspended underneath at the support cylinder, namely the force store, under that the switch contacts to be actuated, and further thereunder in known manner switch-over resistances or varistors.

A further on-load tap changer for a tapped transformer has become known from DE 100 55 406 which develops the load changeover switch of the company publications ‘Stufenschalter Typ R and RM-Inspektionsanleitung’ as well as ‘Stufenschalter Typ R und RM-Technische Daten’ in such a manner that it is possible to dispense with the support cylinder. Instead of that, in DE 100 55 406 fastening of the complete load changeover switch insert to the fixed connecting contacts, which are present in any case and which penetrate the wall of the oil vessel, of the load changeover switch is carried out. However, this is possible only because all components of the load changeover insert are mounted on a mounting plate extending horizontally in the interior of the oil vessel.

In other words: The fixing of the complete load changeover switch insert is carried out in that all its components are fastened to the mounting plate and this mounting plate is fixed by mechanically positive connection of locking bores thereof in locking pins at the fixed connection contacts of the load changeover switch, here at the connecting contact of the load shunt. Due to its construction the mounting plate, particularly the mounting by way of the locking pins, is thus a mechanically highly loaded component which has to bear the entire inherent weight of the load changeover switch and additionally of the force store purely by way of only a few pins. In addition, the pins have to accept the high torque arising in the actual switching over process completed within a few tenths of a second and also brake again at the end of the switching over process. Finally, there is the additional disadvantage that the mounting plate can be produced only in a complicated and costly production process.

It is accordingly the object of the present invention to create a fastening, which consists of simple components, for on-load tap changers and force stores, which at the same time withstands the high mechanical loads, but renders the disadvantageous support cylinder redundant and in addition can be produced economically.

This object is fulfilled by a load changeover switch for a tapped transformer with the features of the first patent claim. The subclaims relate to particularly advantageous developments of the invention.

The general inventive idea consists of fastening both the force store and the load changeover switch not to the mounting plate, but to the force store carrier, in that

additional mounts are to be provided at this and are supported over a large area on the oil vessel, particularly on the respective upper permanent main contact carriers fastened to the oil vessel of each phase of the load changeover switch in such a manner that the force store carrier is fixed not only in horizontal direction, but also in vertical direction and thus produces mechanical load relief of the support plate.

By comparison with the mounting plate, the force store carrier is a solidly constructed component which is permanently adequate for the high mechanical loads and bears without problems not only the intrinsic weight of the force store, but also that of the load changeover switch. Hitherto, the force store carrier was designed purely for mounting individual components of the respectively used force store and for its part fastened to the mounting plate and by way of that in turn to the oil vessel by only a few bolts. A mounting or supporting function of the intrinsic weight of the force store as well as of the load changeover switch was not part of the force store carrier according to the prior art.

Through the solution according to the invention the mounting plate is taken back to its pure original function of actual mounting or fixing of components, such as the vacuum switching tubes or mechanical switch contacts, and no longer, as in the prior art, designed for the purpose of permanently holding the entire load changeover switch plus force store only by way of a few locking pins and fixing it against a torque during the actual switching-over process. According to the invention the several large-area mounts at the force store carrier now take over the mounting. This resolution of the functionalities, i.e. the mounting plate into the pure mounting part function and the force store carrier into the holding part function, makes it possible to undertake a simple, but at the same time also very operationally reliable, construction of the individual components.

The invention will be explained in more detail in the following by way of example with reference to drawings, in which:

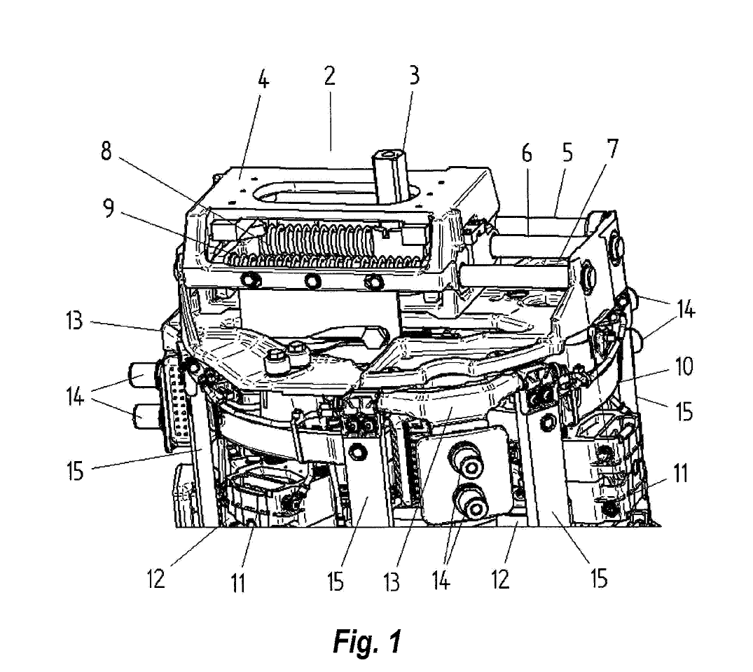

FIG. 1 shows a perspective illustration of a load changeover switch according to

the invention, wherein various components not essential to the invention have been intentionally omitted;

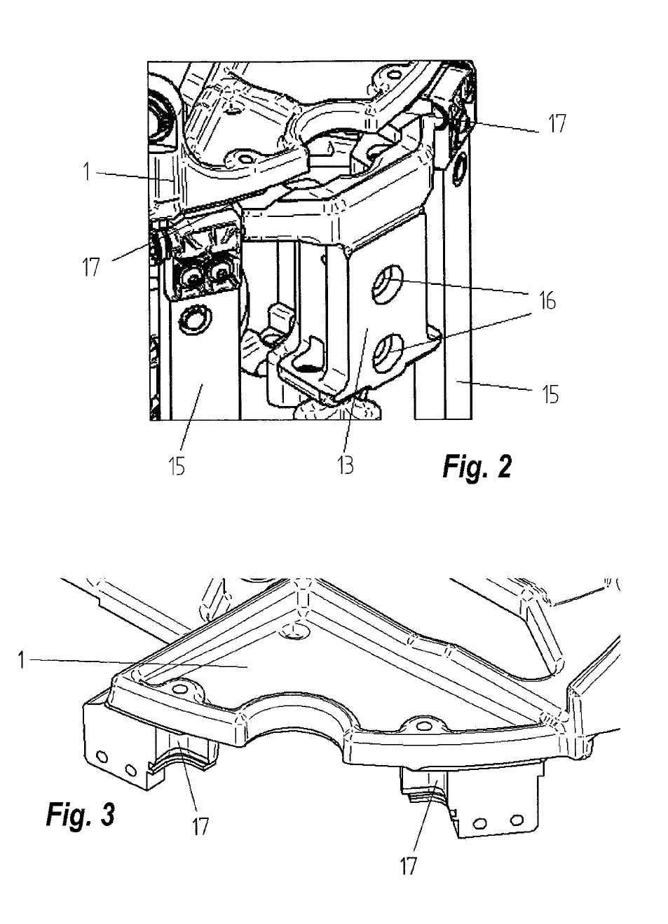

FIG. 2 shows a detail illustration of a load changeover switch according to the invention; and

FIG. 3 shows a further perspective illustration of parts, which are significant for the invention, of a load changeover switch according to the invention.

Since on-load tap changers of that kind are known to the expert basically in function and construction from the prior art, components which are known, but not essential to the invention, are not discussed in more detail in the following description. The load changeover switch illustrated in FIG. 1 has a force store 2 arranged at a force store carrier 1 according to the invention by means of mounts 17, which are not visible in this FIG. and which fix the force store carrier 1 over a large area not only in horizontal direction, but also in vertical direction. A more detailed description of the mounts 17 can be inferred from the explanations with respect to FIGS. 2 and 3. In the case of the illustrated force store 2 an eccentric disc which is connected with the drive shaft 3, but not illustrated, and which actuates a pull-up slide 4 is provided. In addition, the force store 2 has three guide rods 5, 6 and 7 which run parallel and extend longitudinally of the direction of movement of the pull-up slide 4, wherein two of the rods, here the guide rods 6 and 7, are surrounded by force store springs 8 and 9. The third guide rod 5 is, thereagainst, constructed purely as a carrier rod and is not surrounded by a spring.

Provided at a vertical spacing below the force store carrier 1 is a mounting plate 10 which is constructed for receiving or mounting switch contacts (illustrated only in part), such as mechanical contacts 11 or vacuum switching tubes 12, of the load changeover switch. In departure from the prior art, the mounting plate 10 is, however, no longer the supporting element to which the complete load changeover switch and force store are fastened. The mounting plate 10 is now mounted on several support rods 15, which are positioned at the outer circular circumference thereof, and functionally confined purely to the receiving or mounting of components. The switch contacts received by the mounting plate 10 can be mechanical switch contacts 11, vacuum switching tubes 12, thyristors or also a combination of different switch contacts. These are actuated in a predetermined switching sequence, depending on the respective underlying switching, after triggering of the force store 2.

Also illustrated in FIG. 1 are the upper permanent main contact carriers 13 of the respective permanent main contact pairs, which—respectively offset relative to one another by 120 degrees—are disposed at the inner side of the separate oil vessel (not illustrated) of the load changeover switch. Thus, one permanent main contact pair is provided for each phase to be switched. These permanent main contact pairs are equally components known from the prior art and in the static state represent the electrical connection between the respectively connected side A or B of the load changeover switch and of the load shunt, usually the star point.

The entire load changeover switch is enclosed by an oil vessel, which is not illustrated, but is sufficiently known from the prior art, and in the wall of which and penetrating this are provided electrical connecting contacts 14—which are arranged circularly in at least one horizontal plane and for each electrical phase to be switched—for the load shunt on the one hand and each of the two sides A and B of the load changeover switch, between which there is switching over and the connection to the load shunt is produced, on the other hand.

FIG. 2 shows the detail, which is significant for the invention, of the force store carrier 1, wherein this is supported over a large area by means of its plurality of mounts 17 on the solidly constructed block-shaped flanges of the upper permanent main contact carrier 13 in such a manner that the force store carrier 1 is thereby fixed not only in horizontal direction, but also in vertical direction. Since the force store carrier 1 is a solidly constructed component, according to the invention all components of the load changeover switch and of the force store 2 can be fastened thereto without, as is problematic in the prior art, individual components, particularly the plurality of mounts 17, being mechanically overloaded. Bores 16 provided in the respective permanent main contact carrier 13 are constructed for receiving the plurality of connecting contacts 14 and thus for stable fastening of the upper permanent main contact carriers 13 to the oil vessel (not illustrated).

The bracket-shaped mount 17 according to the invention of the force store carrier 1, in which the corresponding solidly constructed block-shaped flanges of the upper permanent main contact carrier 13 engage over a large area, are shown again in detail in FIG. 3. In addition, an electrically insulating layer, which is not, however, shown in this illustration, can be provided at the inner sides of the respective mounts 17.

1. A load changeover switch for a tap changer for uninterrupted switching over between different winding taps of a tapped transformer, with a separate oil vessel which surrounds it and in the wall of which and penetrating this are provided electrical connecting contacts, which are arranged circularly in at least one horizontal plane and for each electrical phase to be switched, for the load shunt on the one hand and each of the two sides A and B of the load changeover switch—between which there is switching over and the connection with the load to shunt is produced—on the other hand, wherein provided in the interior of the oil vessel is a load changeover switch insert, which for its part comprises a force store fastened to a force store carrier, electrical switching means, which are fixed by way of a mounting plate, for load switching over, means for actuation of the electrical switching means, and switch-over resistances, wherein apart from the force store also of the entire load changeover switch insert with all its components is fastenable to the force store carrier and that provided at the force store carrier is a plurality of mounts which are so supported over a large area at the respective upper permanent main contact carriers, which are fastened to the oil vessel, of each phase of the load changeover switch that the force store carrier is fixed not only in horizontal direction, but also in vertical direction.

2. The load changeover switch according to claim 1, wherein the inner sides of the plurality of mounts are dielectrically insulated.
